(19) United States
(12) Patent Application Publication
(10) Pub. No.: US 2011/0239883 A1
(43) Pub. Date: Oct. 6, 2011

(54) PRINTING TABLE ARRANGEMENT

(75) Inventors: Torsten Vegelahn, Sternenfels (DE); Alfred Heupel, Heilbronn (DE); Stephan Bergmoser, Geisenfeld (DE); Michael Hammann, Oberderdingen-Flehingen (DE)

(73) Assignee: Ekra Automatisierungssysteme GmbH, Bonnigheim (DE)

(21) Appl. No.: 13/123,022

(22) PCT Filed: Oct. 8, 2009
(86) PCT No.: PCT/EP2009/007225

§ 371 Date: Apr. 7, 2011

(30) Foreign Application Priority Data
Oct. 9, 2008 (DE) 10 2008 051 052.1

(51) Int. Cl. B41F 1/28

(52) U.S. Cl. 101/474

(57) ABSTRACT

The invention relates to a printing-table arrangement in which a printing table is formed in such a way that a substrate that is to be printed on can be supplied by means of a supply device, the substrate can be adjusted in position relatively with respect to a printing copy, the printing copy and the substrate can be moved relatively towards each other in the mutually adjusted position, a printing medium can be brought onto the substrate with the aid of the printing roller, the printing copy and the substrate that has been printed on can be moved relatively away from each other again, if necessary the substrate that has been printed on can be tested, and the substrate that has been printed on can be discharged again, in which in particular in a common frame (2) at least two printing tables (3, 4) are arranged side by side in such a way that corresponding substrates (11, 12) can be supplied, printed on and discharged again in parallel. At least with two adjacent printing tables (3, 4) the area between the two printing tables (3, 4) is preferably free of guiding, holding and movement elements, if applicable also testing elements, in such a way that if necessary substrates of differing widths are processed, including widths that are greater than those provided for by the dimensions of one individual printing table (3, 4).

The invention relates to a printing-table arrangement by means of which substrates can be printed on in accordance with a fixed printing pattern.

Known printing-table arrangements in this connection have a printing table with which a substrate, such as a printed circuit board, a ceramic plate, a solar cell substrate, a foil and so on, can be introduced into the printing table by way of a supply device. In the printing table first of all alignment (adjustment) of the substrate is effected with respect to a printing copy that is configured in accordance with the printing pattern. Typically either the printing copy, such as a stencil, a screen or a mask, or the substrate is moved, although in principle movement of both is also possible. Subsequently, the printing copy and the substrate are guided towards each other. Typically one of the two is moved, although essentially what matters is that it is a relative movement. The printing-on is then effected, wherein typically a printing medium is pressed through the printing copy by means of one or more doctor blades and is applied to the substrate. Then the substrate and the printing copy are separated from each other again. In the case of sensitive printing patterns, typically a test is effected. The substrate that has been printed on is then removed from the printing table. If a test has taken place, different further processing can be activated on the basis of the test result.

Apparatuses by means of which the printing copy and the substrate can be adjusted with respect to each other are available on the market. Likewise, apparatuses by means of which the printing copy and the substrate can be moved relatively towards each other and away from each other again are basically also known and commercially available. Finally, there are numerous possibilities on the market not only for checking the correct adjustment but also for checking the correct application of the printing medium to the substrate. As an example of the latter, arrangements are known in which after the substrate and the printing copy have been moved away from each other again, a camera penetrates into the interspace that is formed and images specific regions of the substrate and compares them with a desired image. The individual processes can be very time-consuming, in particular if a high level of print quality is to be achieved.

Basing considerations on this, an object of the present invention is to develop a printing-table arrangement in such a way that a more rapid throughput and thus a higher level of effectiveness can be attained.

The object is achieved in accordance with the invention by means of the features of claim 1. The invention is developed by means of the features of the dependent claims.

In accordance with a particular development, above all it is possible to process substrates of differing widths in the printing-table arrangement, in particular even such substrates that are wider than the dimension that is typically provided for in terms of width for a printing table. This permits parallel processing of wide and narrow substrates and also the processing of substrates whose width lies in the range of the dimension of the width of two or more printing tables arranged side by side.

The invention is explained diagrammatically with the aid of an exemplary embodiment that is shown in the drawing with two printing tables that are arranged side by side. In the drawing:

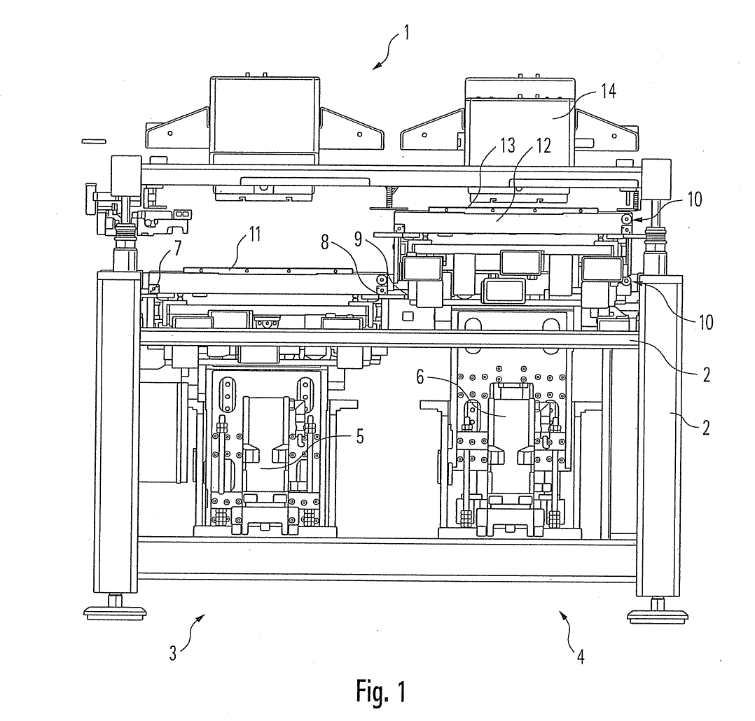

FIG. 1 diagrammatically shows an arrangement with two printing tables side by side in a front view;

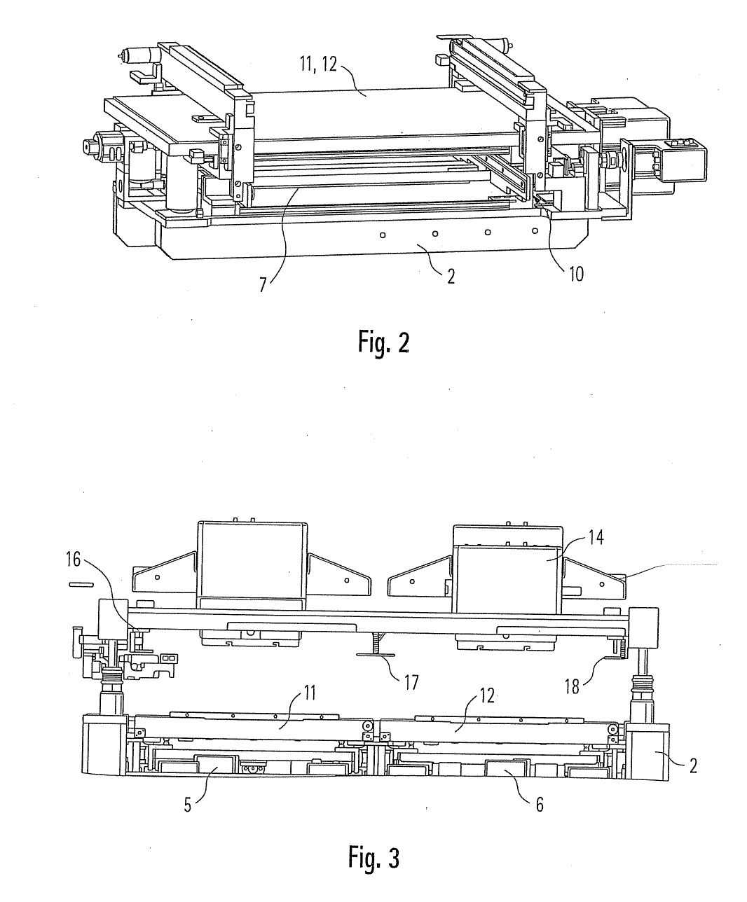

FIG. 2 perspectively shows a portion of the arrangement in accordance with FIG. 1;

FIG. 3 shows a development of the arrangement in accordance with FIG. 1 in a cutaway portion.

In the case of the exemplary embodiment, in accordance with FIG. 1 in the case of a printing-table arrangement 1 in accordance with the invention arranged in a common frame 2 there are a first printing table 3 and a second printing table 4 of in principle the same construction. Of course, it is not necessary for the two printing tables 3 and 4 to have to be of the same design sizes, such as width and length. Furthermore, as mentioned above, it is also possible for more than two printing tables to be arranged in a common frame 2 and thus form a printing-table arrangement 1.

Associated with each printing table 3, 4 there is a respective lifting device 5 and 6. Furthermore, each printing table 3, 4 has a supply device 7, 8 and 9, 10 respectively provided at both edges. Various embodiments of supply devices are available on the market so a more detailed explanation is omitted.

The respective lifting device 5, 6, after supply has been effected by means of the supply device 7, 8 and 9, 10 respectively, takes over a respective substrate 11 and 12 that is to be printed on and lifts it out of a transporting position, which is defined by the supply devices 7, 8 and 9, 10 respectively, into a raised printing position, cf. printing table 4, in which the substrate 12 that is to be printed on here lies opposite a printing copy 13, such as a stencil, a screen or a mask. The printing copy 13 is formed in accordance with a predetermined printing pattern, for example, the printing pattern of an electrical circuit in a printed circuit board etc. In order, for example, to compensate for positional errors caused by the transportation, the substrate 12 that is to be printed on in a manner known per se and the printing copy 13 are aligned or adjusted with respect to each other, for example by means of a movement of rotation about a vertical axis of the lifting device 6. The adjusting process can be monitored and controlled in a manner known per se with the aid of optical means, such as a camera. After alignment, a further relative movement of the aligned substrate 12 and the printing copy 13 towards each other is effected, as is likewise known per se and usual. Then, by means of a doctor blade which is diagrammatically symbolized by means of a print head 14 a printing medium is applied to the substrate 12 through the printing copy 13 in accordance with the printing pattern. A plurality of such print heads 14 can also be provided. After this printing process has been carried out, the substrate 12 which has now been printed on and the printing copy 13 are moved away from each other again. In particular with the aid of the lifting device 6 the substrate 11 is lowered back into the region of the transporting position. In the case of sensitive or complex printing patterns it is usual and known per se, furthermore, to carry out a test, for example in that an optical device, such as a camera, moves into the region between the printing copy 13 and the substrate 12, checks the correct position of specific points with regard to a stored and predetermined desired position, if applicable in consideration of permissible tolerances, and arranges how subsequent further processing of the substrate that has been printed on is to be effected (for example after-processing, rejection, guidance to a fitting arrangement, etc.), as is likewise known per se. After the test has been effected, the substrate 11 that has been printed on is discharged by means of a discharging device that corresponds in terms of construction to the supply devices 7, 8 and 9, 10 respectively. Both printing tables 3, 4 are basically set up in a similar manner. This is not imperative, however.

As regards the supply and discharging devices it is to be noted that such devices are commercially available to a large extent. Depending on the type of substrate essentially what matters is that the substrate is supplied without bending, kinking or damage thereof. As regards the lifting device it is to be noted that depending on the substrate it can be necessary to clamp the substrate in any case at the edge without bending or damaging it. Since such supply devices, discharging devices and lifting devices are basically known, no detailed explanation is given.

In the first instance it is important for the present invention that while both printing tables 3 and 4 of the printing-table arrangement 1 can be operated in parallel, they are not necessarily operated with the same temporal cycle. In particular, it can be expedient to carry out a printing process in one printing table 4, whilst a testing process takes place in the other printing table 3, and vice versa. In such cases, it is possible, for example, to carry out the test in the case of both printing tables 3 and 4 by means of one single common testing device (not shown in particular). Generally, however, each printing table 3, 4 is formed in such a way that the test can take place separately in each case and independently one from the other.

A particular advantage of the printing-table arrangement 1 in accordance with the invention is that in the two printing tables 3, 4 it is also possible to print on different substrates with the aid of correspondingly different printing copies, in particular even if the printing-on and testing process requires different times. It is merely necessary to distribute the supplied substrates correctly on the printing tables in a controlled manner.

If the adjacent supply and discharging devices 8, 9 of adjacent printing tables 3 and 4 are arranged in the plane of transportation so that they are shiftable transversely to the direction of transportation, it is also possible to process substrates of differing widths. In a development thereof, for instance by omitting adjacent supply and discharging devices 8, 9 of adjacent printing tables 3, 4, it is even possible to process, that is, print on substrates whose width corresponds to the total width of both printing tables 3 and 4. In these cases, it is of course necessary to form the supply and discharging devices 7, 10 of the adjacent printing tables 3 and 4 that are remote from each other in such a way that they can carry out the transportation process alone, that is, even if different substrates are to be printed on in the adjacent printing tables 3, 4.

This applies in the given case as well to the lifting devices 5 and 6 of the adjacent printing tables 3 and 4. On the one hand, these must be capable of being moved synchronously and, on the other hand, on the sides of the adjacent printing tables 3 and 4 that are remote from each other be able to take hold of and clamp the respective substrate or the particularly large substrate at the edge in a secure manner without an error as a result, that is, without the possibility of the substrate becoming twisted, bent or kinked or being damaged in another way. Here merely the choice of corresponding devices that are available on the market is what is required here.

If desired, it is also possible to configure the supply and discharging devices of adjacent printing tables that are remote from each other so that they can be shifted in the plane of transportation, for example in order to achieve a situation where different substrates are conveyed substantially centrally through the printing table.

Basically, it is also possible to effect transportation paths of differing widths one on top of the other and configure the associated lifting device in such a way that it carries out its lifting movements in a controlled manner from a plurality of transporting positions.

If, as in the case of the exemplary embodiment, the adjusting movement and the lifting movement, that is, the relative movement between the printing copy and the substrate, are carried out by means of the respective lifting device, and the printing copy remains substantially unchanged, corresponding edge-side support strips 16, 17, 18 can be provided for the respective printing copy. If the holding support of the printing copy is formed in a corresponding manner, it is possible to dispense with the central support strip 17. It would open up the possibility of also using a printing copy that extends over the entire width of a plurality of printing tables.

With the aid of the invention it is thus possible to provide printing-table arrangements with which a high optimum is achieved not only in terms of throughput and thus effectiveness, but also in terms of adaptability to different conditions. By means of the invention it is possible to process not only very small substrates, but also very large substrates in one and the same arrangement. Different substrate sizes can also be processed simultaneously in the arrangement.

The invention has been explained in detail with reference to two printing tables 3 and 4 that are arranged side by side. Basically, in accordance with the invention it is also possible for more than two printing tables arranged in a common frame to form a printing-table arrangement.

The invention can also be applied in similar processing cases, for instance when equipping substrates, further processing substrates that have already been printed on and/or partially equipped, and so on.

1-6. (canceled)

7. A printing table arrangement comprising:
a printing table configured such that a substrate to be printed is fed by a feed unit for feeding a substrate, the position of the substrate adjustable relative to a print pattern, the print pattern and the substrate movable relatively towards each other in the position in which the same are adjusted to each other, a print head for applying a printing medium onto the substrate, the printing pattern and the printed substrate movable relatively away from each other again, if necessary, the printed substrate can be checked and the printed substrate can be led away again, wherein at least a first printing table and a second printing table arranged next to each other in a common frame such that respective substrates are fed, printed and led away again in parallel, wherein each printing table has a lifting unit for lifting a fed substrate from a transport position into a print position and, after applying the printing medium, for lowering again into the transport position, and wherein transport paths of different widths are provided on top of each other and the respective lifting unit is configured such that it carries out its lifting movement in a controlled manner starting from a plurality of transport positions.

8. The printing table arrangement according to claim 7, wherein each printing table has a feed unit provided at both edges.

9. The printing table arrangement according to claim 7, wherein the first printing table carries out a printing process and the second printing table carries out a checking process.

10. The printing table arrangement according to claim 9, wherein the checking process is carried out in the first and second printing tables by a single common checking unit.

11. The printing table arrangement according to claim 10, wherein each of the first and second printing tables is configured such that the checking process takes place in each case separately and independently of each other.

12. The printing table arrangement according to claim 7, wherein the adjustment movement and the lifting movement between print pattern and substrate are carried out by the respective lifting unit.
